(19) United States
(12) Patent Application Publication
(10) Pub. No.: US 2007/0023640 A1
(43) Pub. Date: Feb. 1, 2007

(54) Frontal affinity chromatography/maldi tandem mass spectrometry

(75) Inventors: William R. Davidson, Thornhill (CA); Bori Shushan, Toronto (CA)

Correspondence Address: BERESKIN AND PARR, 40 KING STREET WEST, BOX 401, TORONTO, ON, M5H 3Y2, CA

(73) Assignee: Sciex Division of MDS Inc., Concord (CA)

(21) Appl. No.: 11/133,443

(22) Filed: May 20, 2005

Related U.S. Application Data
(60) Provisional application No. 60/573,099, filed on May 20, 2004.

(51) Int. Cl. H01J 49/00

(52) U.S. Cl. 250/288

(57) ABSTRACT

Sol-gel derived monolithic silica columns containing entrapped dihydrofolate reductase were used for frontal affinity chromatography of small molecule mixtures. The output from the column combined with a second stream containing the matrix molecule (HCCA) and was directly deposited onto a conventional MALDI plate that moved relative to the column via a computer controlled x-y stage, creating a semi-permanent record of the FAC run. The use of MALDI MS allowed for a decoupling of the FAC and MS methods allowing significantly higher ionic strength buffers to be used for FAC studies, which allowed for better retention of protein activity over multiple runs.

### FIELD OF THE INVENTION

The present invention relates to methods of analyzing compounds from chromatographic analyses, in particular using mass spectrometry.

### BACKGROUND TO THE INVENTION

Bioaffinity chromatography has been widely used for sample purification and cleanup,¹ chiral separations,² on-line proteolytic digestion of proteins,³ development of supported biocatalysts,⁴ and more recently for screening of compound libraries via the frontal affinity chromatography (FAC) method.^{5,6} The basic premise of FAC is that continuous infusion of a compound will allow for equilibration of the ligand between the free and bound states, where the precise concentration of free ligand is known. In this case, the breakthrough time of the compound will correspond to the affinity of the ligand for the immobilized biomolecule—ligands with higher affinity will break through later.

The detection of compounds eluting from the column can be accomplished using methods such as fluorescence, radioactivity,⁶ or electrospray ionization-mass spectrometry (ESI-MS).⁵ The former two methods usually make use of either a labeled library, or use a labeled indicator compound which competes against known unlabelled compounds, getting displaced earlier if a stronger binding ligand is present. However, in each case the methods have limited Versatility owing to the need to obtain labeled compounds, and the need for prior knowledge of compounds used in the assay since no structural information is provided by the detector. Hence, these methods tend to be useful only for analysis of discrete compounds.

Interfacing of FAC to ESI-MS, on the other hand, has proven to be a very versatile method for screening of compound mixtures.⁵ Use of MS, and in particular MS/MS detection, provides the opportunity to obtain structural information on a variety of compounds simultaneously. In cases where the identity of compounds in the mixture is known, the analytes can be detected simultaneously using the multiple reaction monitoring (MRM) mode, improving the throughput of the method. While this unique aspect of the FAC/MS technique has been touted as a major advantage for applications such as high-throughput screening of compound mixtures, there are some potential disadvantages that arise as a result of the use of electrospray ionization for introduction of eluents into the mass spectrometer. For example, obtaining a stable electrospray requires the use of low ionic strength eluents, which in some cases can be incompatible with maintaining the activity of the proteins immobilized in the column.⁷ Low ionic strength can also lead to an ineffective double layer, which can cause significant non-selective binding through electrostatic interactions of compounds with the silica column. Furthermore, only one mode of analysis per chromatographic run is possible. Finally, high levels of analytes can lead to large ion currents in the electrospray, which can lead to ion suppression.

### SUMMARY OF THE INVENTION

The present inventors have integrated newly developed sol-gel derived monolithic bioaffinity columns⁷ with matrix assisted laser desorption/ionization-mass spectrometry/mass spectrometry (MALDI-MS/MS) detection, and compared the operation to FAC-ESI/MS/MS by examining the ability of small enzyme inhibitors to interact with entrapped dihydrofolate reductase (DHFR) under a variety of elution conditions (different pH, ionic strength and buffer types). The interfacing involves mixing the column effluent with a suitable matrix followed by deposition of the mixture onto a MALDI plate that is present on a computer controlled x-y translation stage. The chromatographic trace is deposited semi-permanently onto the MALDI plate, allowing for subsequent analysis by MALDI/MS/MS. By scanning the laser over the tracks deposited by the column while monitoring the eluted compounds in MRM mode, the frontal chromatogram can be reconstructed to obtain breakthrough curves for each analyte. It is shown that MALDI/MS/MS has a number of benefits relative to ESI/MS/MS as a detection method for FAC, including: better tolerance to high ionic strength elution buffers, which helps maintain the activity of the protein in the column; the ability to acquire multiple modes of MS data from a single plate in a matter of minutes following the FAC run; and the ability to detect high levels of potential inhibitors with no ion suppression effects. The results show that FAC/MALDI-MS is well suited for high-throughput screening of compound mixtures.

Accordingly, the present invention includes a system for analyzing chemical samples comprising a frontal affinity chromatographic column interfaced to a MALDI mass spectrometer.

The present invention also includes a method of analyzing samples from frontal affinity chromatography (FAC) comprising:

(a) combining effluent from a FAC column with a matrix;

(b) depositing the combination in (a) on to a surface; and

(c) analyzing the deposited combination using MALDI mass spectrometry.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will now be described in relation to the drawings in which:

FIG. 1 is a schematic of the apparatus used for FAC/MS. (A) Apparatus used for FAC-ESI/MS/MS: A switch valve is used to switch from buffer to buffer+analyte, allowing continuous infusion of analytes onto the column. The column outlet is connected to a mixing tee for addition of makeup buffer that flows directly into a mass spectrometer, for example an AB/Sciex API 3000 triple-quadrupole mass spectrometer. (B) Apparatus used for FAC-MALDI/MS/MS: The column outlet is connected to a mixing tee for addition of MALDI matrix solution that flows directly into nebulizer to allow spraying of the mixture onto a MALDI plate that is moved under the column outlet on a computer controlled X-Y translation stage.

FIG. 2 shows typical FAC-ESI/MS/MS traces obtained using protein-loaded and blank DGS/PEO/APTES monolithic columns. Panel A: blank columns containing no protein; Panel B: column containing 50 pmol DHFR (initial loading). N-acetylgluconamide, fluorescein, folic acid, pyrimethamine and trimethoprim were infused at 50 nM. All traces are normalized to the maximum signal obtained after compound breakthrough.

FIG. 3 shows typical FAC-MALDI/MS/MS traces obtained using protein-loaded and blank DGS/PEO/APTES monolithic columns. Panel A: blank columns containing no protein; Panels B-D: column containing 50 pmol DHFR (initial loading) showing breakthrough of N-acetylgluconamide, fluorescein and folic acid at early times (Panel B), trimethoprim (Panel C) and finally pyrimethamine (Panel D). N-acetylgluconamide, fluorescein, folic acid, pyrimethamine and trimethoprim were infused at 50 nM. All traces are normalized to the maximum signal obtained after compound breakthrough.

FIG. 4 is a schematic showing an exemplary embodiment of the interfacing of a FAC column with a MALDI-MS plate.

### DETAILED DESCRIPTION OF THE INVENTION

Herein, the interfacing of bioaffinity columns to MALDI/MS as a new platform for FAC/MS studies is described. Sol-gel derived monolithic silica columns containing entrapped dihydrofolate reductase were used for frontal affinity chromatography of small molecule mixtures. The output from the column combined With a second stream containing the matrix molecule (HCCA) and was directly deposited onto a conventional MALDI plate that moved relative to the column via a computer controlled x-y stage, creating a semi-permanent record of the FAC run. The use of MALDI MS allowed for a decoupling of the FAC and MS methods allowing significantly higher ionic strength buffers to be used for FAC studies, which allowed for better retention of protein activity over multiple runs. Following deposition, MALDI analysis required only a fraction of the chromatographic runtime, and multiple scan modes (positive ion, negative ion, MRM, product ion scans, etc) could be rapidly re-run to extract maximum information from the MALDI trace. Furthermore, high levels of potential inhibitors could be detected via MALDI with no ion suppression effects. Both MALDI and ESI based analysis showed similar retention of inhibitors present in compound mixtures, which were retained via bioaffinity interactions with entrapped DHFR. The results show that FAC/MALDI-MS should provide advantages over FAC/ESI-MS for high-throughput screening of compound mixtures.

The present invention therefore includes a system for analyzing chemical samples comprising a frontal affinity chromatographic column interfaced to a MALDI mass spectrometer.

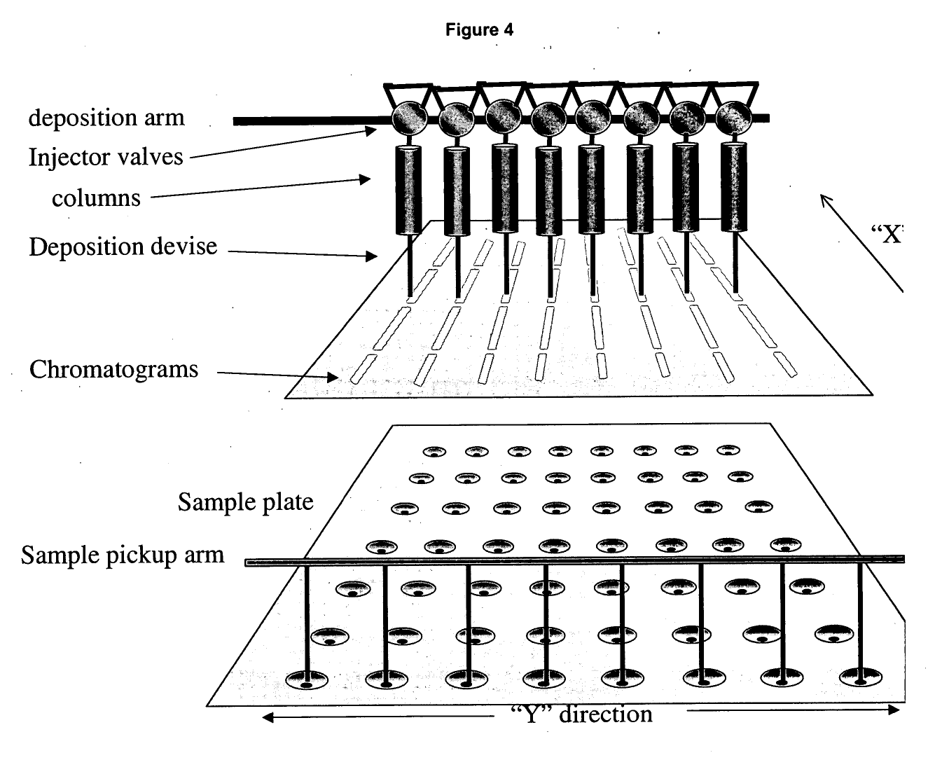

By “interfacing” it is meant that the effluent stream from the FAC column is combined with a matrix material, for example in a separate stream, and the combination is deposited on any suitable surface, for example a standard MALDI-MS plate. The combination may be deposited as trace, for example by movement of the plate under the combined streams. In an embodiment of the invention, the movement of the plate is controlled by a computer. In a further embodiment of the invention the FAC column is a bioaffinity capillary column. A schematic showing an exemplary embodiment of an interface between the FAC column and MS plate is shown in FIG. 4.

The present invention also includes a method of analyzing samples from frontal affinity chromatography (FAC) comprising:

(a) combining effluent from a FAC column with a matrix;

(b) depositing the combination in (a) on to a surface; and

(c) analyzing the deposited combination using MALDI mass spectrometry.

The sample may be a solution containing any number of chemical entities. In an embodiment the method is used in a high through-put screen for modulators, substrates, and/or other compounds that bind to a biological molecule, for example a protein, peptide or nucleic acid (including DNA and RNA). The sample may contain for example, a library of compounds or an extract from a natural source. The method may also be used to screen the products of enzymatic reactions, for example in high throughput enzymatic reaction characterization, or other biomolecular reactions

The following non-limiting examples are illustrative of the present invention:

### EXAMPLES

Chemicals: Tetraethylorthosilicate (TEOS, 99.999%) and 3-aminopropyltriethoxysilane (APTES) were obtained from Aldrich (Oakville, ON). Diglycerylsilane precursors were prepared from TEOS as described elsewhere.⁸ Trimethoprim, pyrimethamine, folic acid, poly(ethyleneglycol) (PEG/PEO, MW 10 kDa) and fluorescein were obtained from Sigma (Oakville, ON). MALDI matrix (6.2 mg/mL HCCA) solution was obtained from Agilent (part no. G2037A). Recombinant dihydrofolate reductase (from E. coli), which was affinity purified on a methotrexate column, was provided by Professor Eric Brown (McMaster University).⁹ Fused silica capillary tubing (150-250 □m i.d., 360 □m outer diameter, polyimide coated) was obtained from Polymicro Technologies (Phoenix, Ariz.). All water was distilled and deionized using a Milli-Q synthesis A10 water purification system. All other reagents were of analytical grade and were used as received.

Procedures

Preparation of Columns: Macroporous silica columns containing entrapped DHFR were prepared as described in detail elsewhere.⁷ Briefly, 100 □m i.d. capillaries were first coated with a layer of APTES to promote electrostatic binding of the monolithic silica column. Silica sols were prepared by first mixing 1 g of DGS (finely ground solid) with 990 □L of H₂O and, optionally, 10 □L of 1 M HCl to yield ˜1.5 mL of hydrolyzed DGS, after 15-25 min of sonication. A second aqueous solution of 50 mM HEPES at pH 7.5 was prepared containing 16% (w/v) PEO (MW=10 kDa) and 0.6% (v/v) APTES. This aqueous solution also contained ca. 20 □M of DHFR. 100 □L of the Buffer/PEG/APTES/DHFR solution was mixed with 100 □L of hydrolyzed DGS and the mixture was immediately loaded via syringe pump into a fused silica capillary (ca. 2 m long). The final composition was of the solution was 8% w/v PEO (10 kDa), 0.3% v/v APTES and 10 □M DHFR in 25 mM HEPES buffer. The mixture became cloudy due to spinodal decomposition (phase separation) over a period of 1-3 sec about 2-3 min after silica polymerization (˜10 min) to generate a hydrated macroporous monolithic column containing entrapped protein. After loading of the sol-gel mixture, the monolithic columns were aged for 10 weeks at 4° C. and then cut into 5 cm lengths before use.

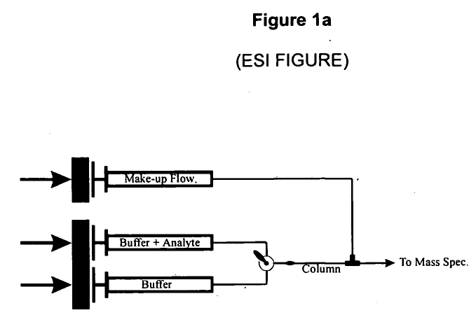

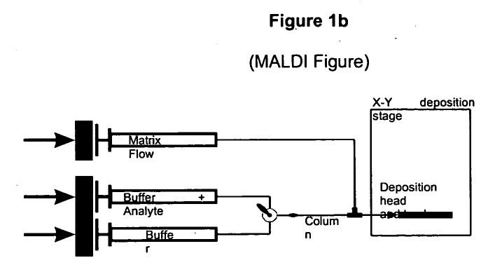

FAC/MS Studies: The frontal affinity chromatography system/mass spectrometer system used for FAC/ESI-MS studies is shown in FIG. 1. Syringe pumps (Harvard Instruments Model 22) were used to deliver solutions, and a flow-switching valve was used to toggle between the assay buffer and the solution containing the compound mixture. This solution was then pumped through the column to achieve equilibrium. Effluent was combined with suitable organic modifiers to assist in the generation of a stable electrospray and detectability of the sprayed components using a triple-quadrupole MS system (PE/Sciex API 3000). An Rheodyne 8125 injector valve was used to switch from buffer to buffer+analyte streams during operation. Columns were interfaced to the FAC system using Luer-capillary adapters (Luer Adapter, Ferrule and Green Microtight Sleeve from Upchurch (P-659, M-100, F-185X)). All other connections between components were achieved using fused silica tubing.

Instrumentation of FAC/MALDI is shown in FIG. 1b. For the MALDI deposition the ESI make-up flow was replaced by HCCA MALDI matrix flow at 5 uL/min. The resulting total flow was then deposited onto MADLI plate(s) using a continuous or discrete deposition process. In the present experiment nebulizer assisted spray was used to deposit a track onto a MADLI plate mounted on an X-Y stage. The stage moved the plate under the spray head at a constant rate 0.2 mm.sec⁻¹.

The deposited plates were analyzed using an AB/Sciex API 4000 triple quadrupole mass spectrometer equipped with an AB/Sciex O-Micron MALDI source and high repetition rate (1.4 kHZ) PowerChip NanoLaser (355 nm) from JDS Uniphase. During MALDI analysis, the deposited track (plate) was moved relative to the desorbing laser beam at a constant speed of 3.8 mm.sec⁻¹ by the MALDI source stage.

Typical FAC/MS experiments involved infusion of mixtures of compounds containing 50 nM of each compound, including N-acetylglucosamine and fluorescein as void markers, folic acid (micromolar substrate) and pyrimethamine and trimethoprim (nM inhibitors). Before the first run, the column was flushed with 0.05 M NH₄OAc buffer (pH 6.6, 100 mM NaCl) for 30 min at a flow rate of 5 μL.min⁻¹ to remove any glycerol and non-entrapped protein and then equilibrated with 2-50 mM NH₄OAc (with or without 100 mM KCl and 2 mM DTT) for 30 min at 5 μL.min⁻¹. All compounds tested were present in 2-50 mM NH₄OAc (with or without 100 mM KCl and 2 mM DTT) and were delivered at a rate of 5 μL.min⁻¹ using the syringe pump. The makeup flow (used to assist in the generation of a stable electrospray) consisted of methanol containing 10% (v/v) NH₄OAc buffer (2 mM) and was delivered at 5 μL.min⁻¹, resulting in a total flowrate of 10 □L.min⁻¹ entering the ESI mass spectrometer. For MALDI, the makeup flow was replaced with a flow of matrix (HCCA 6.2 mg/mL in methanol) at 5 uL.min⁻¹. The ESI mass spectrometer was operated in MRM mode with simultaneous detection of m/z 222→m/z 204 (N-acetylglucosamine); m/z 249→m/z 233 (pyrimethamine); m/z 291→m/z 230 (trimethoprim); m/z 333→m/z 202 (fluorescein) and m/z 442→m/z 295 (folic acid). MALDI MS/MS analysis was also performed using MRM scan mode but due to fragmentation during the MALDI desorption the transitions for N-acetylglucosamine and folic acid changed to 204→138 and 295→176, respectively.

Results

FAC Columns

Details on the monolithic capillary columns used for FAC/MS studies are provided elsewhere.⁷ Columns used in this study had an initial loading of 25 pmol of active DHFR in 5 cm, of which ˜6 pmol is active and accessible in the column. All columns were aged for 10 weeks in a wet state prior to use, and as noted below, the performance of the entrapped protein was very good even after this prolonged period of aging.

FAC/ESI-MS/MS

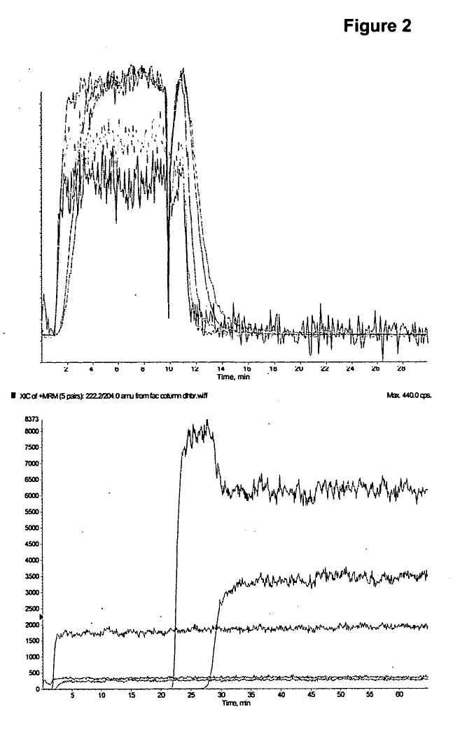

FIG. 2 shows FAC/ESI-MS/MS traces obtained for elution of mixtures of DHFR inhibitors and control compounds through DGS/PEO/APTES columns containing no protein (Panel A) or an initial loading of 50 pmol of active DHFR. The blank column shows the expected breakthrough of all compounds in the first few minutes (between 1 and 4 mins), indicative of minimal non-selective interactions, showing that normal-phase silica chromatography had been suppressed. Panel B shows significant retention of the two DHFR inhibitors, trimethoprim (K_{d}=4 nM, elution time of 22 min) and pyrimethamine (K_{d}=45 nM, retention time 28.5 min), less retention of a weak substrate (folic acid, K_{d}=11 □M, retention time=3 min) and no retention of non-selective ligands (fluorescein, N-acetyl-gluconamide, retention time=1.5 min). This result indicates that DHFR is active when entrapped in the column, in agreement with recent results from our group showing good activity of DHFR when entrapped in DGS derived materials.¹⁰ An interesting aspect of the ESI/MS/MS derived chromatogram is the large reduction in ion current for trimethoprim upon elution of pyrimethamine. Such effects have previously been associated with a “roll-up” phenomenon, wherein stronger binding compounds bump off weaker binders, causing a transient over concentration of the weaker binding ligand.⁵ However, in the present case, the loss in ion current is not due to a roll-up effect, but rather is due to suppression of the trimethoprim ion current, which is prevalent at the concentration of inhibitor used in this study (50 nM). Previous FAC-ESI/MS/MS studies using these compounds did not show such an effect, owing to the lower levels of compound (ca. 20 nM) used in the previous studies.⁷ The ion suppression effect is further confirmed by FAC-MALDI/MS/MS data that is presented below.

The reversal in the expected elution times for trimethoprim and pyrimethamine (based on their respective K_{d} values) has been reported previsously.⁷ Without being limited by theory it is suspected that this phenomenon may be related to differences in on and off rates, which are likely to play a significant role in determining the overall retention time of compounds on the column.

FAC-MALDI/MS/MS

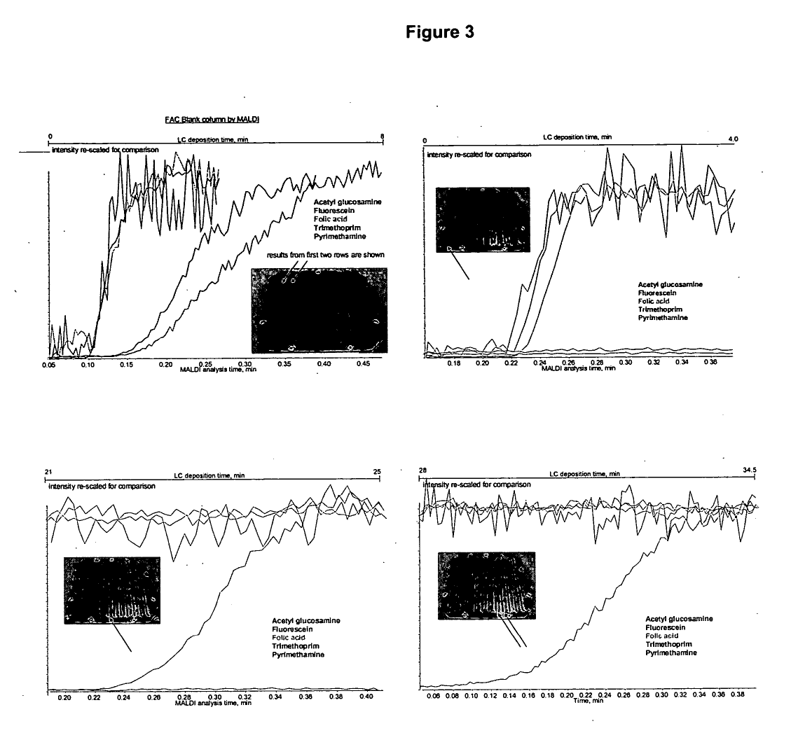

FIG. 3 shows the FAC traces obtained upon desorption from MALDI plates onto which the eluent from either blank (FIG. 3a) or DHFR columns (FIG. 3b-d) had been deposited. In FIG. 3a, the compounds elute in the first two columns that are deposited onto the MALDI plate (arrows show the columns that have been analyzed). The top scale shows LC retention time, while the bottom scale shows MALDI analysis time (i.e., the time over which the laser rasters over the sample traces). As was the case for FAC-ESI/MS/MS, the fluorescein, N-acetylgluconamide and folic acid elute first (1.5 min LC time) followed by trimethoprim (3 min LC time) and pyrimethamine (3.5 min LC time). This is not surprising, as the elution time is dictated by the column rather than the specific type of MS employed for detection. More interestingly, the MS analysis time required for the analysis of the traces on the plate is less than 0.5 min, compared with 8 min of actual LC time. Thus, although the LC deposition time is similar for both methods, it should be possible to use multiple modes of MS to interrogate the same sample (i.e., positive ion mode, negative ion mode, different MRM transitions and collision energies) with each mode requiring only a few minutes to run.

FIGS. 3b-d show the data obtained from the DHFR loaded column. Once again, the two nM inhibitors show significant retention, with retention times that are similar to those obtained from FAC-ESI/MS/MS (trimethoprim=23 min, pyrimethamine=32 min). The slightly longer elution times relative to ESI/MS reflect the fact that the column used for the FAC/MALDI study was slightly longer than the one used for FAC/ESI. An important finding from the FAC/MALDI analysis is the complete absence of ion suppression, which shows another important advantage of the MALDI MS method. The level of noise is also somewhat lower for pyrimethamine and trimethoprim in the MALDI/MS/MS data, owing to the ability to adjust the MALDI scan time to allow longer integration of signals.

Discussion

Capillary scale meso/macroporous sol-gel based monolithic bioaffinity columns are ideally suited for the screening of compound mixtures using frontal affinity chromatography with mass spectrometric detection for identification of specific compounds in the mixture. A particular advantage of the sol-gel derived columns is their good compatibility with a variety of different proteins. While the current work focused on entrapment of a soluble enzyme, the sol-gel method employed herein is also amenable to the entrapment of a wide range of important drug targets, including membrane-bound enzymes¹⁰ and receptors,¹¹ and even whole cells.¹² Furthermore, entrapment into DGS derived materials allows immobilization of labile enzymes, such as Factor Xa and Cox-II,¹⁰ which are difficult to immobilize by other methods. Thus, the monolithic columns may find use in screening of compound mixtures against a wide variety of useful targets. Another advantage of the low id monolithic columns is the ability to interface the capillary columns directly to an ESI or MALDI mass spectrometer is a key advantage of the new columns, and is likely to make them suitable for HTS of compound mixtures using FAC/MS. In particular, the low id of the present monolithic columns allows them to deposit a relatively thin stream of analyte on a MALDI plate, allowing for high density deposition (up to 12 traces per plate). The time capacity of a MALDI plate is determined by the width of the deposited track as well as its deposition speed. Reducing the deposition speed will increase the plate capacity but it will also degrade the LC resolution as any instant in time is deposited over a finite area, given by the spray diameter, and overlap of two adjacent events increases. Since the spray diameter directly affects both the capacity of a plate and fidelity of the chromatography record, it is important to keep it as small as possible. In practical terms, the loss of chromatographic resolution that can be tolerated dictates the lowest deposition speed. Since the LC run and analysis are now decoupled into two time independent events, the ratio between deposition and interrogation speed determines how many re-runs and different analysis experiments can be performed over a track at a time saving over an LC re-run.

While FAC-MALDI/MS/MS has provided good chromatographic results, several issues remain to be explored to optimize performance. For example, new deposition methods should be examined that can produce thinner, less disperse traces to give a higher density of analyte on the plate, which should lead to a higher analyte concentration in laser beam and thus a better LOD. Lower diameter columns may also be beneficial as these could allow faster LC separations with lower flowrates that are compatible with deposition of thin tracks on the MALDI target. In addition, methods to suppress the inherent background from the MALDI matrix would be beneficial, as this would minimize the need for subtraction of matrix background signals from analyte signals. While this is less of a problem when using MRM mode, and indeed was not required in the current study, such effects can become problematic if drug compounds have product ions that are similar in structure to commonly used MALDI matrix species.

Even though these issues remain to be explored, the advantages of MALDI/MS/MS detection for frontal affinity chromatography are numerous. The use of MALDI/MS/MS provides better tolerance of high ionic strength buffers, less ion suppression, faster MS analysis times, access to more modes of MS analysis per LC run, and the ability to acquire data using different mass analyzers (triple-quadrupole, TOF, Q-TOF) from the same sample, which could be beneficial in cases where higher molecular weight species were analyzed. Overall, these benefits show that FAC-MALDI should be useful for eventual HTS studies.

While the present invention has been described with reference to the above examples, it is to be understood that the invention is not limited to the disclosed examples. To the contrary, the invention is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.
¹. a) Hage, D. S. J. Chromatog. B 1998, 715, 3-38 b) Hage, D. S.; Clin. Chem. 1999, 45, 593-615; c) Weller, M. G. Fresenius J. Anal. Chem. 2000, 366, 635-645; d) Muronetz, V. I.; Sholukh, M.; Korpela, T. J. Biochem. Biophys. Methods 2001, 49, 29-47; e) Baczek, T.; Kaliszan, R. J. Biochem. Biophys. Methods 2001, 49, 83-98; f) Burgess, R. R.; Thompson, N. E. Curr. Opin. Biotechnol. 2002, 13, 304-308.
². a) Hage, D. S.; Noctor, T. A. G.; Wainer, I. W. J. Chromatogr. A 1995, 693, 23-32; b) Hofstetter, H.; Hofstetter, O. Schurig, V. J. Microcolumn September 1998, 10, 287-291; c) Hofstetter, O.; Lindstrom, H.; Hofstetter, H. Anal. Chem. 2002, 74, 2119-2125. d) Fitos, I.; Visy, J.; Simonyi, M. J. Biochem. Biophys. Methods 2002, 54, 71-84.
³. a) Hsieh, Y. L.; Wang, H.; Elicone, C.; Mark, J.; Martin, S. A.; Regnier, F. Anal. Chem. 1996, 68, 455-462; b) Wang, C.; Oleschuk, R.; Ouchen, F.; Li, J.; Thibault, P.; Harrison, D. J. Rapid. Commun. Mass. Spectrom. 2000, 14, 1377-1383; c) Wang, S.; Regnier, F. E. J. Chromatogr. A 2001, 913, 429-436; d) Peterson, D. S.; Rohr, T.; Svec, F.; Frechet, J. M. J. J. Proteome Res. 2002, 1, 563-568; e) Peterson, D. S.; Rohr, T.; Svec, F.; Frechet, J. M. J. Anal. Chem. 2002, 74, 4081-4088; f) Slysz, G. W.; Schriemer, D. C. Rapid Commun. Mass Spec. 2003, 17, 1044-1050.
⁴. Prazeres, D.; Miguel F.; Cabral, J. M. S. in: Multiphase Bioreactor Design, Cabral, J. M. S.; Mota, M.; Tramper, J. (Eds.) Taylor & Francis Ltd., London, UK, 2001, pp. 135-180.
⁵. a) Schriemer, D. C.; Bundle, D. R.; Li, L.; Hindsgaul, O. Angew. Chem., Int. Ed. Engl. 1998, 37, 3383; b) Zhang, B.; Palcic, M. M.; Schriemer, D. C.; Alvarez-Manilla, G.; Pierce, M.; Hindsgaul, O. Anal. Biochem. 2001, 299, 173-182.
⁶. a) Baynham, M. T.; Patel, S.; Moaddel, R.; Wainer, I. W.; J. Chromatogr. B 2002, 772, 155-161; b) Moaddel, R.; Lu, L.; Baynham, M.; Wainer, I. W. J. Chromatogr. B 2002, 768, 41-53; c) Moaddel, R.; Cloix, J.-F.; Ertem, G.; Wainer, I. W. Pharmaceut. Res. 2002, 19, 104-107; d) Moaddel, R.; Wainer, I. W.; J. Pharmaceut. Biomed. Anal. 2003, 30, 1715-1724.
⁷. Hodgson, R. J.; Chen, Y.; Zhang, Z.; Tleugabulova, D.; Long, H.; Zhao, X.; Organ, M.; Brook, M. A.; Brennan, J. D.; Anal. Chem. 2004, 76, in press.
⁸. Brook, M. A.; Chen, Y.; Guo, K.; Zhang, Z.; Jin, W.; Deisingh, A.; Cruz-Aguado, J.; Brennan, J. D. J. Sol-Gel Sci. Technol. 2004, in press.
⁹. Zolli-Juran, M.; Cechetto, J. D.; Harlen, H.; Daigle, D. M.; Brown, E. D. Bioorg. Med. Chem. Lett. 2003, 13, 2493.
¹⁰. Besanger, T. R.; Chen, Y.; Deisingh, A. K.; Hodgson, R.; Jin, W.; Mayer, S.; Brook, M. A.; Brennan, J. D. Anal. Chem. 2003, 75, 2382-2391.
¹¹. Besagner, T. R.; Brennan, J. D. Angew. Chem. Int. Ed. Eng. 2004, submitted.
¹². Livage, J.; Coradin, T.; Roux, C. J. Phys.: Condens. Matter 2001, 13, R673.

We claim:

1. A system for analyzing chemical samples comprising a frontal affinity chromatographic column interfaced to a MALDI mass spectrometer.

2. A method of analyzing samples from frontal affinity chromatography (FAC) comprising:
(a) combining effluent from a FAC column with a matrix;
(b) depositing the combination in (a) on to a surface; and
(c) analyzing the deposited combination using MALDI mass spectrometry.
